(19) United States
(12) Patent Application Publication
(10) Pub. No.: US 2010/0039241 A1
(43) Pub. Date: Feb. 18, 2010

(54) POWER LINE COMMUNICATION DEVICE

(76) Inventors: Toshihiko Maruoka, Osaka (JP); Osamu Katou, Kyoto (JP)

Correspondence Address: MCDERMOTT WILL & EMERY LLP, 600 13TH STREET, NW, WASHINGTON, DC, 20005-3096, US

(21) Appl. No.: 12/526,901

(22) PCT Filed: Sep. 8, 2008
(86) PCT No.: PCT/JP2008/002472

§ 371 Date: Aug. 12, 2009

(30) Foreign Application Priority Data
Nov. 9, 2007 (JP) 2007-292532

(51) Int. Cl. G05B 11/01

(52) U.S. Cl. 340/310.11

(57) ABSTRACT

A terminal best in the reception state for a signal from a controller of a neighboring network is determined as the controller of the own network, to ensure sharing of inter-network control. When the reception state is not good, a terminal worst in reception state is determined as the controller, to make the own network independent from a neighboring network and hence reduce interference of a reference signal and a control signal outputted from the own terminal with the neighboring network.

### TECHNICAL FIELD

The present invention relates to a power line communication system using home power lines as a communication medium, and more particularly, to a power line communication device used in such a power line communication system.

### BACKGROUND ART

In power line communication, power lines provided for supply of electric power are used as a communication medium. Since power lines are electrically connected with each other, a plurality of networks may sometimes exist on the same communication medium. In this case, communication of a network to which a terminal in question (own terminal) does not belong (hereinafter referred to as a “neighboring network”) is recognized as noise, which interferes with communication of a network to which the own terminal belongs. The influence of a neighboring network will be small as long as the neighboring network is distant in terms of the power line communication path because of attenuation through the path of power lines themselves, attenuation through branching and the like. However, in the case of constructing a network for each floor in a large-scale building and cases like that, in particular, a neighboring network small in attenuation may exist. In some disclosure, a neighboring network is integrated with a network to which the own terminal belongs, to eliminate the influence of the neighboring network (see Patent Document 1, for example).

### Patent Document 1: Japanese Laid-Open Patent Publication No. 2006-135943

### DISCLOSURE OF THE INVENTION

### Problems to be Solved by the Invention

When a plurality of neighboring networks are integrated into one network, some terminal may be out of the reach of a signal from a controller. In such a case, a control signal issued by the controller must be relayed. By relaying a control signal, however, the band will be consumed with the control signal. Also, integration into one network is unavailable between different power line communication schemes. Even if networks of different schemes are handled as one network with only control signals being virtually integrated, the problem described above will occur.

Moreover, when a plurality of neighboring networks are integrated into one network, or only control signals are virtually integrated, even communication of terminals in networks distant from each other in terms of the power line communication path is controlled with the same control signal. Such terminals will then be subjected to unnecessary communication limitation.

### Means for Solving the Problems

The power line communication device of the present invention is a power line communication device used for a power line communication system in which a plurality of terminals conduct communication via a power line, the power line communication device being allowed to become a controller that is a terminal outputting a control signal and/or a reference signal to any other terminal, the power line communication device including: reception means for receiving a communication signal, a control signal, or a reference signal via a power line; transmission means for transmitting a communication signal, a control signal, or a reference signal via a power line; neighboring network detection means for detecting, from a signal received via the reception means, a signal from a controller of a network (hereinafter referred to as a “neighboring network”) other than a network to which the own terminal belongs, to examine a neighboring network reception state that is the reception state for a signal from a controller of a neighboring network; comparison means for comparing the neighboring network reception state; and controller determination means for transmitting a controller change request signal or a controller change permission signal from the transmission means and determining the controller based on the comparison result from the comparison means and/or a signal received via the reception means.

In the power line communication device described above, preferably, the comparison means compares the neighboring network reception state with a predetermined first value, and in the case that the own terminal is a non-controller terminal and that the neighboring network reception state is found better than the first value from the comparison result from the comparison means, the controller determination means transmits a controller change request signal requesting that the own terminal should become the controller from the transmission means, and allows the own terminal to become the controller when having received a controller change permission signal responding to the controller change request signal via the reception means, and in the case that the own terminal is a controller terminal and that the neighboring network reception state is found not better than the first value from the comparison result from the comparison means or the neighboring network detection means fails to detect a signal from a controller of a neighboring network, the controller determination means transmits a controller change permission signal from the transmission means when having received a controller change request signal via the reception means, to allow the own terminal to become a non-controller terminal.

In the power line communication device described above, preferably, in the case that the own terminal is a controller terminal and that the neighboring network reception state is found better than the first value from the comparison result from the comparison means, the transmission means periodically notifies a non-controller terminal that there is a neighboring network, and in the case that the own terminal is a non-controller terminal and that the reception means has been notified by the controller that there is a neighboring network, the controller determination means does not issue a controller change request signal even if the neighboring network reception state is better than the first value.

In the power line communication device described above, preferably, in the case that the own terminal is a controller, when the own terminal has a neighboring network reception state, the transmission means transmits the neighboring network reception state to a non-controller terminal, and the controller determination means transmits a controller change permission signal from the transmission means when having received a controller change request signal via the reception means, to allow the own terminal to become a non-controller terminal, and in the case that the own terminal is not a controller, the reception means receives the neighboring network reception state of the controller, the comparison means compares the neighboring network reception state of the controller received via the reception means with the neighboring network reception state of the own terminal, and the controller determination means transmits a controller change request signal requesting that the own terminal should become the controller via the transmission means when the neighboring network reception state of the own terminal is found better than the neighboring network reception state of the controller from the comparison result from the comparison means, and allows the own terminal to become the controller when having received a controller change permission signal responding to the controller change request signal via the reception means.

In the power line communication device described above, preferably, in the case that the own terminal is a controller, the comparison means compares the neighboring network reception state of the own terminal with a predetermined first value, if the neighboring network reception state of the own terminal is not better than the first value, the transmission means does not transmit the neighboring network reception state of the own terminal to a non-controller terminal even though the own terminal has a neighboring network reception state, and in the case that the own terminal is not a controller, the comparison means compares the neighboring network reception state of the controller received via the reception means with the neighboring network reception state of the own terminal and also compares the neighboring network reception state of the own terminal with the first value, and the controller determination means does not transmit a controller change request signal when the neighboring network reception state of the own terminal is not better than the first value even if the neighboring network reception state of the own terminal is found better than the neighboring network reception state of the controller from the comparison result from the comparison means.

In the power line communication device described above, preferably, in the case that the own terminal is not a controller, the transmission means transmits the neighboring network reception state of the own terminal to the controller, and the controller determination means transmits a controller change permission signal from the transmission means when having received a controller change request signal via the reception means, to allow the own terminal to become the controller, and in the case that the own terminal is a controller, the reception means receives the neighboring network reception state of a non-controller terminal, the comparison means compares the neighboring network reception state of the own terminal with the neighboring network reception state of the non-controller terminal, and if a terminal having the best neighboring network reception state is found not to be the own terminal from the comparison result from the comparison means, the controller determination means transmits a controller change request signal requesting that the terminal having the best neighboring network reception state should become the controller to the terminal having the best neighboring network reception state via the transmission means, and allows the own terminal to become a non-controller terminal when having received a controller change permission signal via the reception means.

In the power line communication device described above, preferably, in the case that the own terminal is not a controller, the comparison means compares the neighboring network reception state of the own terminal with a predetermined first value, and the transmission means does not transmit the neighboring network reception state of the own terminal to the controller when the neighboring network reception state is found not better than the first value from the comparison result from the comparison means even though the own terminal has a neighboring network reception state.

In the power line communication device described above, preferably, in the case that the own terminal is not a controller, the transmission means transmits the neighboring network reception state of the own terminal to the controller, and the controller determination means transmits a controller change permission signal from the transmission means when having received a controller change request signal via the reception means, to allow the own terminal to become the controller, and in the case that the own terminal is a controller, the reception means receives the neighboring network reception state of a non-controller terminal, the comparison means compares the neighboring network reception state of the own terminal, the neighboring network reception state of the non-controller terminal and a predetermined first value with one another, and when it is found from the comparison result from the comparison means that a terminal having the best neighboring network reception state is not the own terminal, if the best neighboring network reception state is found better than the first value, the controller determination means transmits a controller change request signal to the terminal having the best neighboring network reception state requesting that the terminal having the best neighboring network reception state should become the controller, or if the best neighboring network reception state is found not better than the first value, the controller determination means transmits a controller change request signal to a non-controller terminal that has not received a neighboring network reception state via the reception means or to a terminal found to have the worst neighboring network reception state from the comparison result from the comparison means requesting that such a terminal should be the controller, and allows the own terminal to become a non-controller terminal when having received a controller change permission signal in response to the controller change request signal via the reception means.

In the power line communication device described above, preferably, the neighboring network detection means examines the reception state for a signal from a controller of a neighboring network for each neighboring network, and determines a computation result of all or part of such reception states as the neighboring network reception state.

In the power line communication device described above, preferably, the neighboring network detection means examines the reception state for a signal from a controller of a neighboring network for each neighboring network, and determines the sum or the sum of logarithms of such reception states as the neighboring network reception state.

In the power line communication device described above, preferably, the neighboring network detection means examines the reception state for a signal from a controller of a neighboring network for each neighboring network, and determines the sum or the sum of logarithms of reception states that are equal to or more than a predetermined first value as the neighboring network reception state.

In the power line communication device described above, preferably, the neighboring network detection means examines the reception state for a signal from a controller of a neighboring network for each neighboring network, and determines the best reception state as the neighboring network reception state.

In the power line communication device described above, preferably, the neighboring network detection means examines the reception state for a signal from a controller of a neighboring network for each neighboring network, and determines the best reception state within a fixed time as the neighboring network reception state. In the power line communication device described above, preferably, the good neighboring network reception state represents that the reception error rate of a signal transmitted from a controller of a neighboring network is low, that the reception electric power of a signal transmitted from a controller of a neighboring network is high, that the reception rate of a signal transmitted from a controller of a neighboring network is high, or that the carrier to interference and noise ratio (CINR) of a signal received from a controller of a neighboring network is high.

In the power line communication device described above, preferably, the neighboring network detection means examines reception of a signal from a controller of a neighboring network for each neighboring network and the good neighboring network reception state represents that the number of neighboring networks detected by the neighboring network detection means is large.

In the power line communication device described above, preferably, the neighboring network detection means examines reception of a signal from a controller of a neighboring network for each neighboring network, and the good neighboring network reception state represents that the number of neighboring networks for which the reception error rate is equal to or lower than a predetermined value, or the reception electric power, the reception rate or the CINR of a received signal is equal to or higher than a predetermined value is large.

In the power line communication device described above, preferably, when a terminal that has not received a neighboring network reception state or a terminal having the worst neighboring network reception state becomes the controller, the transmission means and the reception means conduct communication robust against noise for communication of all terminals in the own network.

In the power line communication device described above, preferably, when a terminal that has not received a neighboring network reception state or a terminal having the worst neighboring network reception state becomes the controller, the transmission means and the reception means conduct communication with a frame divided into smaller retransmission units for communication of all terminals in the own network.

In the power line communication device described above, preferably, when a terminal that has not received a neighboring network reception state or a terminal having the worst neighboring network reception state becomes the controller, the transmission means and the reception means conduct communication robust against noise for communication with a terminal that has detected a neighboring network.

In the power line communication device described above, preferably, when a terminal that has not received a neighboring network reception state or a terminal having the worst neighboring network reception state becomes the controller, the transmission means and the reception means conduct communication with a frame divided into smaller re-transmission units for communication with a terminal that has detected a neighboring network.

### EFFECT OF THE INVENTION

According to the present invention, when the reception state for a signal from a controller of a neighboring network is better than a predetermined value, the controller right of the own network is shifted to a terminal having the best reception state. Hence, communication of control signals between the controllers of the own network and the neighboring network can be made smoothly.

When the reception state for a signal from a controller of a neighboring network is not good, the controller right of the own network is shifted to a terminal bad in reception state. Hence, the influence of a signal from the controller of the own network on the neighboring network can be reduced.

Once the controller right of the own network has been shifted to a terminal bad in the reception state for a signal from a controller of a neighboring network, communication robust in noise resistance or communication in small retransmission units is conducted. This ensures robust communication against a burst of noise occurring due to communication of the neighboring network.

### BRIEF DESCRIPTION OF THE DRAWINGS

FIG. 1 is a view showing an example of the connection relationship of a power line communication system of Embodiment 1 of the present invention.

FIG. 2 is a view showing the output timing of a reference signal and the like.

FIG. 3 is a block diagram showing a major part of the configuration of each terminal.

FIG. 4 is a view showing a procedure of controller change.

FIG. 5 is a view showing the connection relationship after the controller change.

FIG. 6 is a view showing an example of the connection relationship of a power line communication system of Embodiment 2 of the present invention.

FIG. 7 is a block diagram showing a major part of the configuration of each terminal.

FIG. 8 is a view showing a procedure of controller change.

FIG. 9 is a view showing an example of the connection relationship of a power line communication system of Embodiment 3 of the present invention.

FIG. 10 is a block diagram showing a major part of the configuration of each terminal.

FIG. 11 is a view showing a procedure of controller change.

FIG. 12 is a view showing the connection relationship of the power line communication system after change of the power line state.

### DESCRIPTION OF REFERENCE CHARACTERS

A, B, C Network
A1 to A3, B1 to B3, C1 to C3 Power line communication device
100, 110, 114 Switchboard
121 Reception section
122, 222, 322 Neighboring network detection section
123, 223, 323 Comparison section
124, 224, 324 Controller determination section
125, 325 Transmission section

### BEST MODE FOR CARRYING OUT THE INVENTION

Hereinafter, embodiments of the present invention will be described with reference to the relevant drawings. Note that in the description of the embodiments, components having similar functions to those already described are denoted by the same reference numerals and description thereof is not repeated.

### Embodiment 1

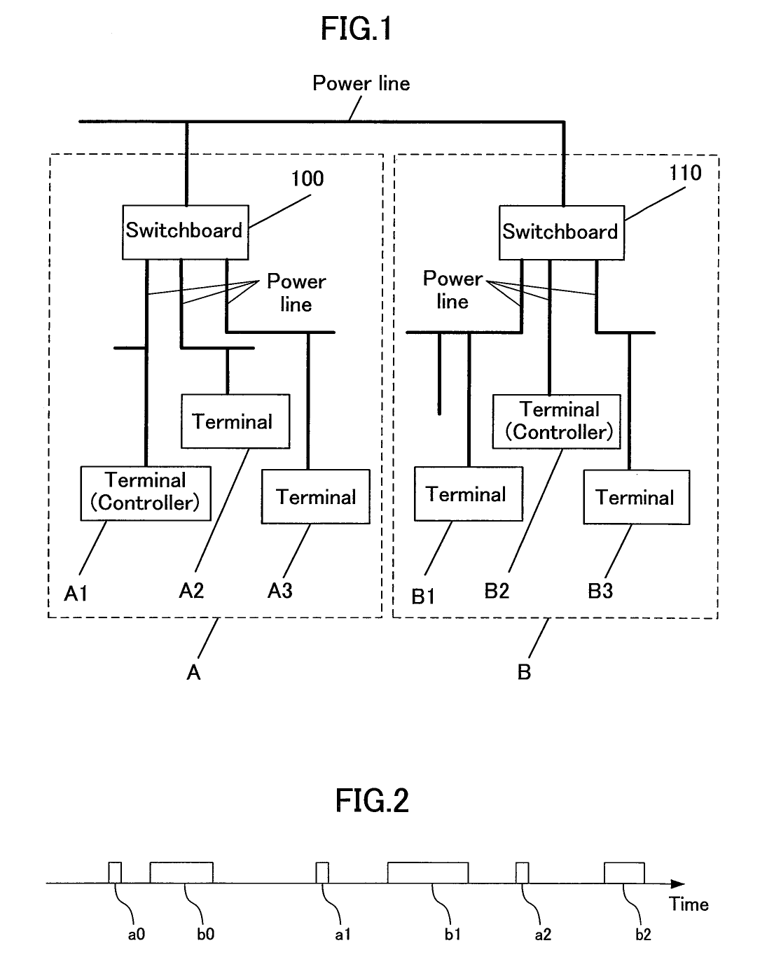

FIG. 1 is a view showing an example of the connection relationship of a power line communication system of Embodiment 1 of the present invention. In this power line communication system, a plurality of networks A and B exist on the same communication medium (power line). Power line communication devices (hereinafter referred to as terminals) A1, A2 and A3 that perform power line communication are connected with one another via power lines and a switchboard 100 to constitute the network A (herein assumed as the own network). Likewise, terminals B1, B2 and B3 are connected with one another via power lines and a switchboard 110 to constitute the network B (herein assumed as a neighboring network).

Note that in FIG. 1, the path length of each of the power lines for connecting the terminals A1 to A3 and B1 to B3 diagrammatically represents the magnitude of the path length in terms of power line communication.

The terminals A1 and B2 respectively serve as controllers that transmit control signals or reference signals of the networks A and B. Assume that while one controller is provided for one network, any terminal can serve as the controller.

(Configuration of Power Line Communication Devices A1 to A3 and B1 to B3)

Each of the terminals A1 to A3 and B1 to B3 has a function of outputting a time reference signal periodically when it is assigned as the controller. FIG. 2 is a view illustrating the output timing of the reference signal and the like. In FIG. 2, a0, a1 and a2 denote the reference signal periodically outputted from a controller, and b0, b1 and b2 denote communication signals between terminals.

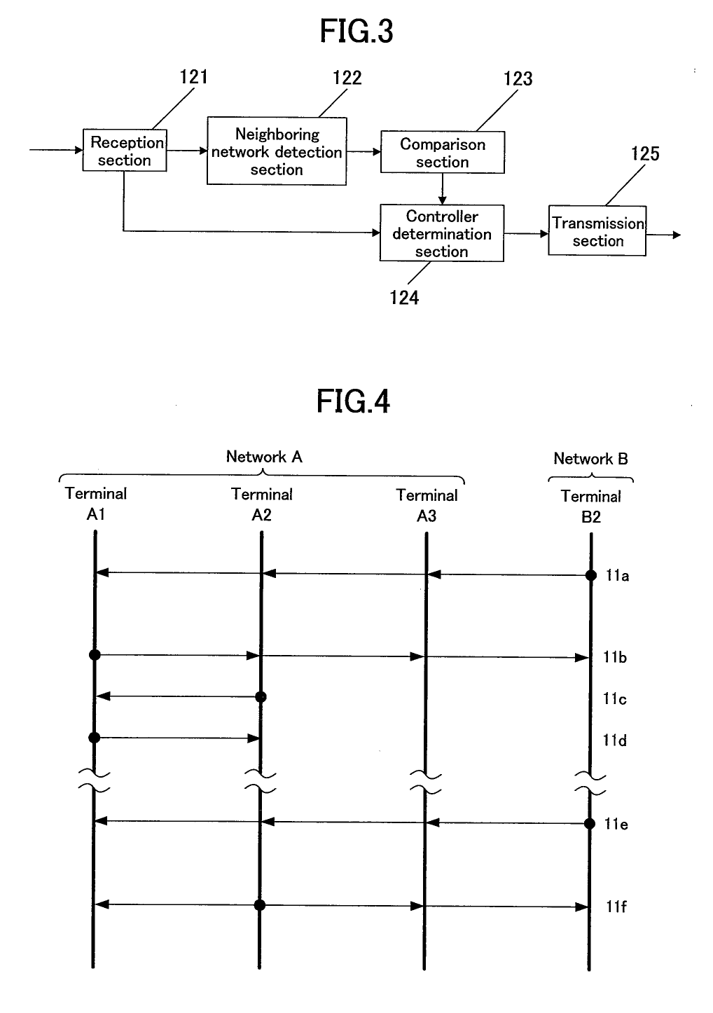

FIG. 3 is a block diagram showing a major part of each of the terminals A1 to A3 and B1 to B3. As shown in FIG. 3, each of the terminals A1 to A3 and B1 to B3 includes a reception section 121, a neighboring network detection section 122, a comparison section 123, a controller determination section 124 and a transmission section 125.

The reception section 121 receives a reference signal, a control signal and a communication signal via a power line. The control signal includes a controller change request signal, a controller change permission signal, etc., which will be described later. The neighboring network detection section 122 examines the reference signal received via the reception section 121 for a value identifying the network (e.g., network ID, etc.) to detect presence or absence of a neighboring network, and also calculates the carrier to interference and noise ratio (CINR) indicating the state of the communication. The comparison section 123 compares the CINR for a neighboring network calculated by the neighboring network detection section 122 with a predetermined reference if the neighboring network detection section 122 determines that “a neighboring network exists.” The controller determination section 124 prepares a controller change request signal based on the comparison result from the comparison section 123, and determines whether or not the own terminal becomes the controller based on a controller change permission signal received via the reception section 121. The transmission section 125 transmits a reference signal, a control signal and a communication signal.

(Operation of Power Line Communication Devices A1 to A3 and B1 to B3)

The operation of the terminals A1 to A3 and B1 to B3 will be described. First, the operation of each of the terminals A1 to A3 and B1 to B3 when the terminal itself is the controller will be described.

When the reception section 121 receives a controller change request signal addressed to the own terminal, the controller determination section 124 examines the comparison result from the comparison section 123. If the result is “no neighboring network exists” or “the CINR is lower than the predetermined reference value,” the controller determination section 124 allows the own terminal to become a non-controller terminal, and outputs a controller change allowance signal from the transmission section 125. Also, the controller determination section 124 periodically examines the comparison result from the comparison section 123, and, if the comparison result is that “the CINR is higher than the predetermined reference value,” notifies each non-controller terminal that the controller is receiving a neighboring network via the transmission section 125.

The operation of each of the terminals A1 to A3 and B1 to B3 when the terminal itself is not the controller will then be described.

The controller determination section 124 examines the comparison result from the comparison section 123, and if the result is that “the CINR is higher than the predetermined reference value” and also no notification that the controller is receiving a neighboring network has been received from the controller, outputs a controller change request signal from the transmission section 125. Once the reception section 121 receives a controller change allowance signal, the controller determination section 124 allows the own terminal to become the controller.

Next, an example of change of the controller of the network A from the terminal A1 to the terminal A2 based on a reference signal from the terminal B2 that is the controller of the network B in FIG. 1 will be described with reference to FIG. 4.

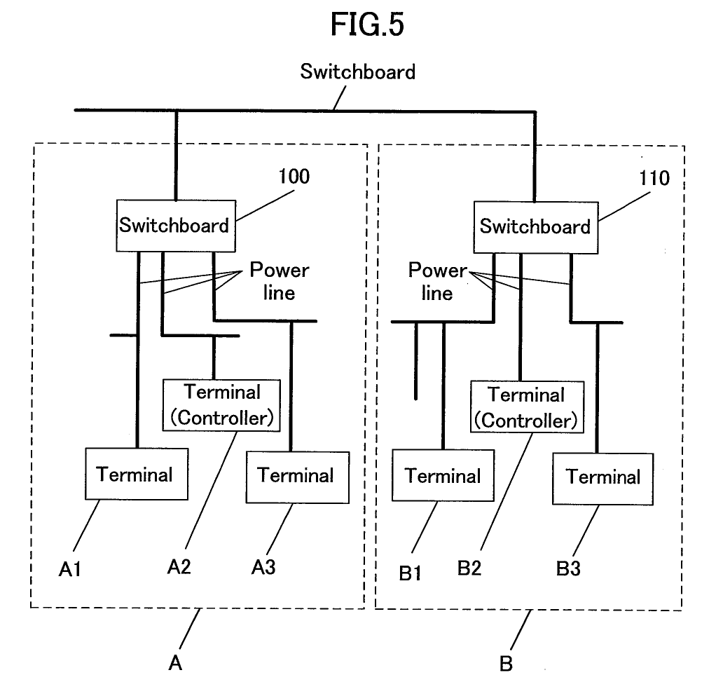

First, the terminal B2, as the controller of the network B, outputs a reference signal periodically (11a). Assume that the terminals A1 and A2 of the network A have received this reference signal and the CINR of the reference signal has exceeded a predetermined value only in the terminal A2. Assume also that the terminal A3 has failed to receive the reference signal. The terminal A1, as the controller of the network A, outputs a reference signal periodically (11b). Since the CINR of the reference signal from the terminal B2 has not exceeded the predetermined value in the terminal A1, the reference signal (11b) from the terminal A1 includes no reception of a neighboring network (network B in this case). The terminal A3, which has failed to receive the reference signal (11a) from the terminal B2, does nothing. In the terminal A2, which is a non-controller terminal, the CINR of the reference signal (11a) from the network B to which it does not belong has exceeded the reference value. Hence, the terminal A2 outputs a controller change request signal to the terminal A1 as the controller (11c). Having received the controller change request signal from the terminal A2, the terminal A1, in which the CINR of the reference signal from the terminal B2 belonging to the network B has not exceeded the reference value, transmits a controller change permission signal to the terminal A2 (11d). The terminal A1 then becomes a non-controller terminal. Having received the controller change permission signal (11d), the terminal A2 becomes the controller. Hence, as shown in FIG. 5, the controller of the network A changes from the terminal A1 to the terminal A2. At and after this change, the CINR of the reference signal from the terminal B2 belonging to the network B exceeds the reference value as long as the state of the power lines is unchanged (11e). The terminal A2 therefore notifies the terminals A1 and A3 of reception of the neighboring network (network B in this case) as the controller, as well as transmitting the reference signal (11f). Since the terminal A2 does not issue a controller change permission signal, there is no change of the controller. The terminals A1 and A3, being notified of reception of the neighboring network by the controller, do not issue a controller change request signal even if the CINR exceeds the reference value in these terminals.

In Embodiment 1 described above, the controller notified non-controller terminals of reception of a neighboring network. Similar results will also be obtained when no such notification is made.

### Embodiment 2

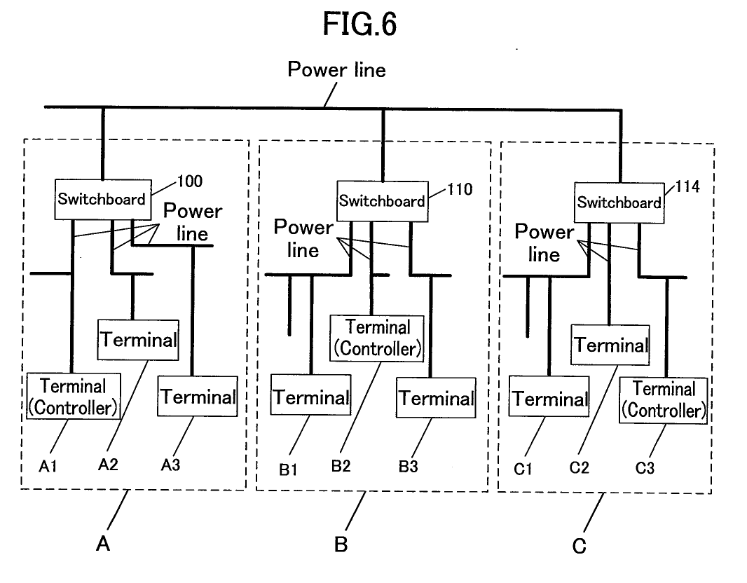

FIG. 6 is a view showing an example of the connection relationship of a power line communication system of Embodiment 2 of the present invention. In this power line communication system, a plurality of networks A, B and C exist on the same communication medium (power line). Power line communication devices (terminals) A1, A2 and A3 that perform power line communication are connected with one another via power lines and a switchboard 100 to constitute the network A (herein assumed as the own network). Likewise, terminals B1, B2 and B3 are connected with one another via power lines and a switchboard 110 to constitute the network B (herein assumed as a neighboring network), and terminals C1, C2 and C3 are connected with one another via power lines and a switchboard 114 to constitute the network C (herein assumed as another neighboring network).

Note that in FIG. 6, the path length of each of the power lines for connecting the terminals A1 to A3, B1 to B3 and C1 to C3 diagrammatically represents the magnitude of the path length in terms of power line communication.

The terminals A1, B2 and C3 respectively serve as the controllers that transmit control signals or reference signals of the networks A, B and C. Assume that while one controller is provided for one network, any terminal can serve as the controller.

(Configuration of Power Line Communication Devices A1 to A3, B1 to B3 and C1 to C3)

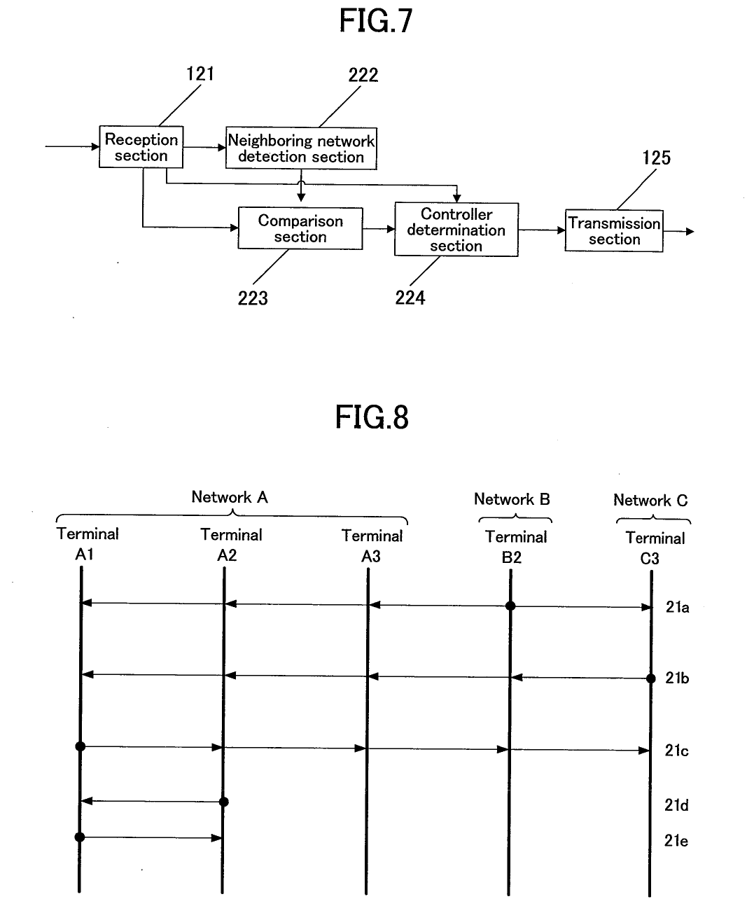

FIG. 7 is a block diagram showing a major part of each of the terminals A1 to A3, B1 to B3 and C1 to C3. As shown in FIG. 7, each of the terminals A1 to A3, B1 to B3 and C1 to C3 includes a reception section 121, a neighboring network detection section 222, a comparison section 223, a controller determination section 224 and a transmission section 125.

The neighboring network detection section 222 examines a reference signal received via the reception section 121 for a value identifying the network (e.g., network ID, etc.) to detect presence or absence of a neighboring network. The neighboring network detection section 222 also calculates the CINR indicating the state of the communication for each neighboring network, and determines the number of terminals for which the CINR is equal to or more than a predetermined reference value as the neighboring network reception state. The comparison section 223 compares the neighboring network reception state calculated by the neighboring network detection section 222 with the neighboring network reception state of a terminal serving as the controller or a non-controller terminal received via the reception section 121. The controller determination section 224 prepares a controller change request signal based on the comparison result from the comparison section 223, and determines whether or not the own terminal becomes the controller based on a controller change allowance signal received via the reception section 121.

(Operation of Power Line Communication Devices A1 to A3, B1 to B3 and C1 to C3)

The operation of the terminals A1 to A3, B1 to B3 and C1 to C3 will be described. First, the operation of each of the terminals A1 to A3, B1 to B3 and C1 to C3 when the terminal itself is the controller will be described.

When the reception section 121 receives a controller change request signal addressed to the own terminal, the controller determination section 224 examines the comparison result from the comparison section 223. If the neighboring network reception state of the own terminal is lower than the neighboring network reception state of the terminal that has issued the controller change request signal, the controller determination section 224 allows the own terminal to become a non-controller controller, and transmits a controller change allowance signal from the transmission section 125. The controller also transmits the neighboring network reception state calculated by the neighboring network detection section 222 periodically to the non-controller terminals.

The operation of each of the terminals A1 to A3, B1 to B3 and C1 to C3 when the terminal itself is not a controller will then be described.

The controller determination section 224 examines the comparison result from the comparison section 223, and if the neighboring network reception state of the own terminal is higher than the neighboring network reception state of a terminal that has transmitted a controller change request signal, outputs a controller change request signal from the transmission section 125.

Next, a procedure in which the controller of the network A is changed from the terminal A1 to the terminal A2 based on a reference signal from the terminal B2 that is the controller of the network B, and a reference signal from the terminal C3 that is the controller of the network C shown in FIG. 6 will be described with reference to FIG. 8.

The terminal B2, as the controller of the network B, outputs a reference signal periodically (21a). Assume that the terminals A1, A2 and A3 of the network A have received this reference signal and the CINR of the reference signal has exceeded a predetermined reference value in all of these terminals. Also, the terminal C3, as the controller of the network C, outputs a reference signal periodically (21b). Assume that the terminals A1 and A2 of the network A have received this reference signal and the CINR of the reference signal has exceeded the predetermined reference value only in the terminal A2. In this situation, the neighboring network reception state is 1 in the terminals A1 and A3 of the network A, and 2 in the terminal A2. The terminal A1, as the controller of the network A, transmits a reference signal including its neighboring network reception state (21c). The terminals A2 and A3 compare the neighboring network reception state of the controller included in the reference signal from the terminal A1 with their own neighboring network reception states. The terminal A3 does nothing for this because its neighboring network reception state is the same as the neighboring network reception state of the controller A1. The terminal A2, whose neighboring network reception state is higher than the neighboring network reception state of the controller A1, transmits a controller change request signal together with its neighboring network reception state to the terminal A1 as the controller (21d). The terminal A1, having received the controller change request signal from the terminal A2, and knowing that the neighboring network reception state of the terminal A2 is higher than its neighboring network reception state, transmits a controller change permission signal to the terminal A2 (21e), and becomes a non-controller terminal. The terminal A2, having received the controller change permission signal, becomes the controller. In this way, the controller of the network A changes from the terminal A1 to the terminal A2.

In Embodiment 2, the controller transmits its neighboring network reception state to the non-terminal terminals. Alternatively, similar results will also be obtained when no such transmission of the neighboring network reception state is made.

The neighboring network detection section 222 uses the CINR for the calculation of the neighboring network reception state. Alternatively, a similar effect will be clearly obtained by use of any of the error rate, the reception electric power and the reception rate.

The neighboring network reception state calculated by the neighboring network detection section 222 is the number of terminals for which the CINR is equal to or more than a predetermined reference value. Alternatively, a similar effect will be clearly obtained by use of the added value of any of the error rate, the reception electric power, the reception rate and the CINR calculated for each network, or the number of terminals a signal from which has been received.

### Embodiment 3

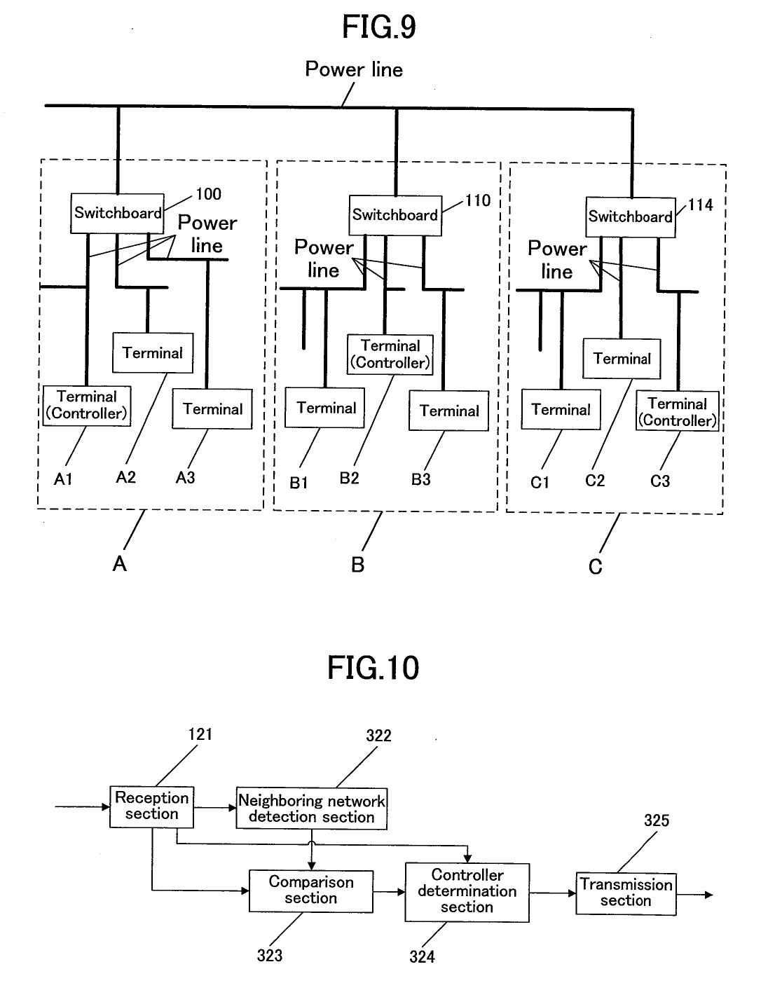

FIG. 9 is a view showing an example of the connection relationship of a power line communication system of Embodiment 3 of the present invention. In this power line communication system, a plurality of networks A, B and C exist on the same communication medium (power line). Power line communication devices (terminals) A1, A2 and A3 that perform power line communication are connected with one another via power lines and a Switchboard 100 to constitute the network A (herein assumed as the own network). Likewise, terminals B1, B2 and B3 are connected with one another via power lines and a switchboard 110 to constitute the network B (herein assumed as a neighboring network), and terminals C1, C2 and C3 are connected with one another via power lines and a switchboard 114 to constitute the network C (herein assumed as another neighboring network).

Note that in FIG. 9, the path length of each of the power lines for connecting the terminals A1 to A3, B1 to B3 and C1 to C3 diagrammatically represents the magnitude of the path length in terms of power line communication.

The terminals A1, B2 and C3 respectively serve as the controllers that transmit control signals or reference signals of the networks A, B and C. Assume that while one controller is provided for one network, any terminal can serve as the controller.

(Configuration of Power Line Communication Devices A1 to A3, B1 to B3 and C1 to C3)

FIG. 10 is a block diagram showing a major part of each of the terminals A1 to A3, B1 to B3 and C1 to C3. As shown in FIG. 10, each of the terminals A1 to A3, B1 to B3 and C1 to C3 includes a reception section 121, a neighboring network detection section 322, a comparison section 323, a controller determination section 324 and a transmission section 325.

The neighboring network detection section 322 examines a reference signal received via the reception section 121 for a value identifying the network (e.g., network ID, etc.) to detect presence or absence of a neighboring network. The neighboring network detection section 322 also calculates the CINR indicating the state of the communication for each neighboring network, and determines the sum of CINR values that are equal to or more than a predetermined reference value, or if there is no network for which the CINR is equal to or more than the predetermined reference value, the largest one of CINR values that are less than the predetermined reference value in the networks, as the neighboring network reception state. Note that if the neighboring network detection section 322 has not detected any relevant neighboring network, the neighboring network reception state is set to 0. The comparison section 323 compares the neighboring network reception state calculated by the neighboring network detection section 322 with the neighboring network reception state of a non-controller terminal received via the reception section 121. The controller determination section 324 prepares a controller change request signal based on the comparison result from the comparison section 323, and determines whether or not the own terminal becomes the controller based on a controller change allowance signal received via the reception section 121. The transmission section 325 transmits a reference signal, a communication signal and a control signal such as the controller change request signal, and also, if there is a network for which the CINR is less than the predetermined reference value, divides the communication signal and transmits the divided ones.

(Operation of Power Line Communication Devices A1 to A3, B1 to B3 and C1 to C3)

The operation of the terminals A1 to A3, B1 to B3 and C1 to C3 will be described. First, the operation of each of the terminals A1 to A3, B1 to B3 and C1 to C3 when the terminal itself is not a controller will be described.

When receiving a controller change request signal addressed to the own terminal via the reception section 121, the controller determination section 324 determines the own terminal as the controller and outputs a controller change permission signal from the transmission section 125. When the signal received via the reception section 121 is a reference signal from a neighboring network, the neighboring network detection section 322 calculates the neighboring network reception state. The controller determination section 324 transmits the neighboring network reception state calculated by the neighboring network detection section 322 to the controller periodically.

The operation of each of the terminals A1 to A3, B1 to B3 and C1 to C3 when the terminal itself is the controller will then be described.

When the signal received via the reception section 121 is a reference signal from a neighboring network, the neighboring network detection section 322 calculates the neighboring network reception state, as in the case that the own terminal is not the controller. The comparison section 323 first compares the neighboring network reception state of each non-controller terminal received via the reception section 121 with the neighboring network reception state calculated by the neighboring network detection section 222. The comparison section 323 identifies a terminal which is largest in neighboring network reception state if there is a terminal whose neighboring network reception state is equal to or more than the predetermined reference value, or a terminal which is smallest in neighboring network reception state if there is no such terminal. When the own terminal is not the determined terminal or not included in the determined terminals, the transmission section 125 outputs a controller change request signal to the determined terminal or one of the determined terminals.

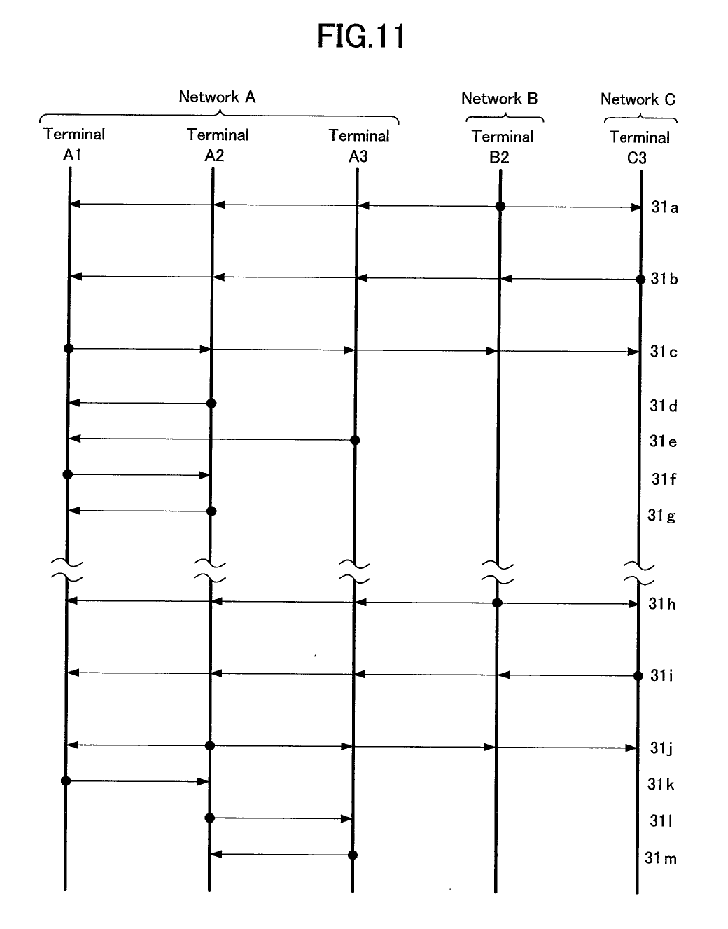

Next, a procedure in which the controller of the network A is changed from the terminal A1 to the terminal A2 based on a reference signal from the terminal B2 that is the controller of the network B, and a reference signal from the terminal C3 that is the controller of the network C shown in FIG. 9 will be described with reference to FIG. 11.

The terminal B2, as the controller of the network B, outputs a reference signal periodically. Assume that the terminals A1, A2 and A3 of the network A receive this reference signal and their CINR values of the reference signal are “5,” “6” and “4,” respectively, all of which exceed a predetermined reference of 4 (31a).

Also, the terminal C3, as the controller of the network C, outputs a reference signal periodically. Assume that the terminals A1, A2 and A3 of the network A receive this reference signal and their CINR values of the reference signal are “3,” “4” and “2,” respectively, in which only the terminal A2 has a value equal to or more than the predetermined reference of 4 (31b).

The terminal A1, as the controller of the network A, transmits a reference signal periodically (31c).

The terminal A2 transmits “10,” the sum of CINR values that are equal to or more than the predetermined reference value of “4,” to the controller terminal A1 as the neighboring network reception state (31d).

The terminal A3 transmits “4,” the sum of CINR values that are equal to or more than the predetermined reference value of “4,” to the controller terminal A1 as the neighboring network reception state (31e).

The terminal A1 as the controller of the network A assigns “5,” the sum of CINR values that are equal to or more than the predetermined reference value of “4,” to the neighboring network reception state, and compares this neighboring network reception state with the neighboring network reception states of the terminals A2 and A3. In this example, there are terminals whose neighboring network reception state is equal to or more than the predetermined reference value of “4,” and the terminal largest in neighboring network reception state among such terminals is the terminal A2 that is not the own terminal. Hence, the terminal A1 transmits a controller change request to the terminal A2 (31f).

The terminal A2, having received the controller change request, becomes the controller, and transmits a controller change permission signal to the terminal A1 (31g). The terminal A1 then becomes a non-controller terminal.

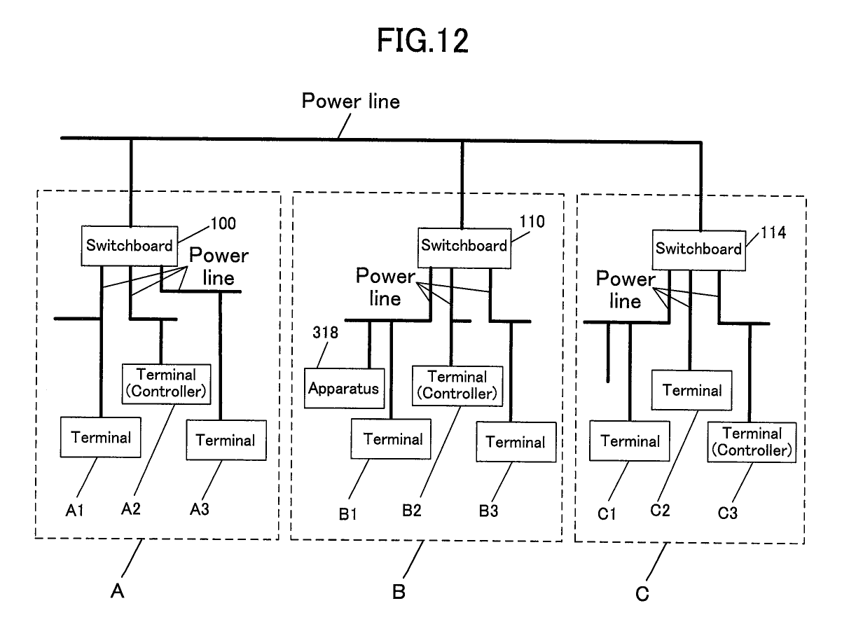

Suppose that, after the change of the controller of the network A from the terminal A1 to the terminal A2, an apparatus 318 was connected to a power line of the network. B as shown in FIG. 12, and the state of the power lines were changed under the influence of noise of the apparatus 318 or an impedance variation. Assume that while the terminals A1 and A2 receive the reference signal of the terminal B2 with respective CINR values of “2” and “3,” the terminal A3 fails to receive the reference signal (31h). Assume also that, while the terminal A2 receives the reference signal of the terminal C3 with its CINR of “1,” the terminals A1 and A3 fail to receive the reference signal (31i).

After the terminal A2 as the controller of the network A outputs a reference signal (31j), the terminal A1 transmits “2,” the largest one of CINR values that do not exceed the predetermined reference value of “4,” to the terminal A2 as the controller as the neighboring network reception state (31k). The terminal A3, which has failed to receive any of the reference signals from the terminals B2 and C3, transmits no neighboring network reception state to the controller A2. The terminal A2 as the controller assigns “3,” the largest one of CINR values that do not exceed the predetermined reference value of “4,” to the neighboring network reception state, and compares this value with the neighboring network reception states of the terminals A2 and A3. None of the terminals A1 to A3 have a CINR exceeding the predetermined reference value of “4,” and the terminal having the smallest neighboring network reception state among such terminals is the terminal A3 that has not received any of the reference signals from the neighboring networks B and C, not the own terminal A2. Hence, the terminal A2 transmits a controller change request to the terminal A3 (31l). The terminal A3, having received the controller change request, becomes the controller of the network A and transmits a controller change permission signal to the terminal A2 (31m). The terminal A2 then becomes a non-controller terminal. In this situation, the communication among the terminals A1, A2 and A3 in the network A is limited in communication size, and division is made for any communication exceeding the capacity.

In Embodiment 3, a non-controller terminal that has failed to receive the reference signal from the controller of any neighboring network does not transmit its neighboring network reception state to the controller of the own network (network to which the own terminal belongs). Alternatively, such a terminal may notify the controller of the own network of the failure of reception. This brings the effect of ensuring the communicability of the terminal.

In Embodiment 3, even when there is no network for which the CINR is equal to or more than the predetermined reference value, the largest one of CINR values that are less than the predetermined reference value in the networks is assigned to the neighboring network reception state. Alternatively, the neighboring network reception state may be assigned “0” when the CINR is less than the predetermined reference value. This brings the effect of facilitating the calculation of the neighboring network reception state.

The CINR is used for the comparison by the comparison sections 123 and 323 in Embodiments 1 and 3. Alternatively, a similar effect will be clearly obtained by use of any of the error rate, the reception electric power and the reception rate.

In Embodiment 3, when the neighboring network reception state does not exceed the predetermined reference value of “4” in any terminal, and a terminal having the smallest neighboring network reception state among the terminals becomes the controller, limitations are imposed on the communication size. Alternatively, a similar effect will also be obtained by adopting a communication scheme having high noise immunity to burst noise.

In Embodiment 3, when the neighboring network reception state does not exceed the predetermined reference value of 4 in any terminal and a terminal having the smallest neighboring network reception state among the terminals becomes the controller, limitations are imposed on the communication size for all communications within the own network. Alternatively, limitations may be imposed on the communication size, or a communication scheme having high noise immunity to burst noise may be adopted, only when the own terminal or a communication partner is detecting a neighboring network. This brings the effect of further improving the transmission efficiency.

The controller in Embodiment 1 transmits whether or not the own terminal has received a neighboring network, while the controller in Embodiment 2 transmits the neighboring network reception state of the own terminal, as part of the reference signal. Such information is not necessarily included in the reference signal, but may be separately transmitted periodically. In this case, also, a similar effect will be obtained.

The controller in Embodiment 1 transmits whether or not the own terminal has received a neighboring network, while the controller in Embodiment 2 transmits the neighboring network reception state of the own terminal, as part of the reference signal. Such information may otherwise be transmitted when a neighboring network is received. In this case, also, a similar effect will be obtained.

A non-controller terminal transmits a controller change request signal in Embodiments 1 and 2, or transmits the neighboring network reception state in Embodiment 3, succeeding a reference signal. The transmission may not be made succeeding a reference signal, but be made periodically. In this case, also, a similar effect will be obtained.

In Embodiments 1 to 3, the neighboring network reception state is calculated as necessary. Alternatively, the average value, the minimum value, or the maximum value within a fixed time may be determined as the neighboring network reception state. In this case, the shift of the controller will not occur frequently, and hence the effect of permitting more stable communication can be obtained.

In Embodiments 1 and 2, a non-controller terminal issues a controller change request signal based on the comparison result from the comparators 123 and 223, respectively. If the number of terminals in the own network capable of communicating with this own terminal is smaller than the number of terminals in the own network capable of communicating with the current controller, this own terminal may be made not to issue the controller change request signal. This brings the effect of permitting stable communication in the own network.

In Embodiment 3, the controller issues a controller change request signal based on the comparison result from the comparator 323. If the number of terminals in the own network capable of communicating with a terminal to which the controller change request signal is addressed is smaller than the number of terminals in the own network capable of communicating with the current controller, the controller may be made not to issue the controller change request signal. This brings the effect of permitting stable communication in the own network.

### INDUSTRIAL APPLICABILITY

In the power line communication system according to the present invention, in existence of a neighboring network, the position of the controller of the own network is changed according to the degree of proximity of the neighboring network. This permits smooth communication of control signals between the controllers of the own and neighboring networks. Also, it is possible to reduce noise in a neighboring network caused by a control signal or a reference signal outputted from the controller of the own network. Hence, the present invention is useful as a power line communication system using home power lines and a power line communication device and the like used in such a system.

1-20. (canceled)

21. A power line communication device used for a power line communication system in which a plurality of terminals conduct communication via a power line, the power line communication device being allowed to become a controller that is a terminal outputting a control signal and/or a reference signal to any other terminal, the power line communication device comprising:
reception means for receiving a communication signal, a control signal, or a reference signal via a power line;
transmission means for transmitting a communication signal, a control signal, or a reference signal via a power line;
neighboring network detection means for detecting, from a signal received via the reception means, a signal from a controller of a network (hereinafter referred to as a “neighboring network”) other than a network to which the own terminal belongs, to examine a neighboring network reception state that is the reception state for a signal from a controller of a neighboring network;
comparison means for comparing the neighboring network reception state; and
controller determination means for transmitting a controller change request signal or a controller change permission signal from the transmission means and determining the controller based on the comparison result from the comparison means and/or a signal received via the reception means,
wherein the comparison means compares the neighboring network reception state with a predetermined first value, and
in the case that the own terminal is a non-controller terminal and that the neighboring network reception state is found better than the first value from the comparison result from the comparison means, the controller determination means transmits a controller change request signal requesting that the own terminal should become the controller from the transmission means, and allows the own terminal to become the controller when having received a controller change permission signal responding to the controller change request signal via the reception means, and
in the case that the own terminal is a controller terminal and that the neighboring network reception state is found not better than the first value from the comparison result from the comparison means or the neighboring network detection means fails to detect a signal from a controller of a neighboring network, the controller determination means transmits a controller change permission signal from the transmission means when having received a controller change request signal via the reception means, to allow the own terminal to become a non-controller terminal, and
wherein in the case that the own terminal is a controller terminal and that the neighboring network reception state is found better than the first value from the comparison result from the comparison means, the transmission means periodically notifies a non-controller terminal that there is a neighboring network, and
in the case that the own terminal is a non-controller terminal and that the reception means has been notified by the controller that there is a neighboring network, the controller determination means does not issue a controller change request signal even if the neighboring network reception state is better than the first value.

22. A power line communication device used for a power line communication system in which a plurality of terminals conduct communication via a power line, the power line communication device being allowed to become a controller that is a terminal outputting a control signal and/or a reference signal to any other terminal, the power line communication device comprising:
reception means for receiving a communication signal, a control signal, or a reference signal via a power line;
transmission means for transmitting a communication signal, a control signal, or a reference signal via a power line;
neighboring network detection means for detecting, from a signal received via the reception means, a signal from a controller of a network (hereinafter, called a neighboring network) other than a network to which the own terminal belongs, to examine a neighboring network reception state that is the reception state for a signal from a controller of a neighboring network;
comparison means for comparing the neighboring network reception state; and
controller determination means for transmitting a controller change request signal or a controller change permission signal from the transmission means and determining the controller based on the comparison result from the comparison means and/or a signal received via the reception means,
wherein in the case that the own terminal is a controller,
when the own terminal has a neighboring network reception state, the transmission means transmits the neighboring network reception state to a non-controller terminal, and
the controller determination means transmits a controller change permission signal from the transmission means when having received a controller change request signal via the reception means, to allow the own terminal to become a non-controller terminal, and
in the case that the own terminal is not a controller,
the reception means receives the neighboring network reception state of the controller,
the comparison means compares the neighboring network reception state of the controller received via the reception means with the neighboring network reception state of the own terminal, and
the controller determination means transmits a controller change request signal requesting that the own terminal should become the controller from the transmission means when the neighboring network reception state of the own terminal is found better than the neighboring network reception state of the controller from the comparison result from the comparison means, and allows the own terminal to become the controller when having received a controller change permission signal responding to the controller change request signal via the reception means.

23. The power line communication device of claim 22, wherein in the case that the own terminal is a controller,
the comparison means compares the neighboring network reception state of the own terminal with a predetermined first value,
if the neighboring network reception state of the own terminal is not better than the first value, the transmission means does not transmit the neighboring network reception state of the own terminal to a non-controller terminal even though the own terminal has a neighboring network reception state, and
in the case that the own terminal is not a controller,
the comparison means compares the neighboring network reception state of the controller received via the reception means with the neighboring network reception state of the own terminal and also compares the neighboring network reception state of the own terminal with the first value, and
the controller determination means does not transmit a controller change request signal when the neighboring network reception state of the own terminal is not better than the first value even if the neighboring network reception state of the own terminal is found better than the neighboring network reception state of the controller from the comparison result from the comparison means.

24. A power line communication device used for a power line communication system in which a plurality of terminals conduct communication via a power line, the power line communication device being allowed to become a controller that is a terminal outputting a control signal and/or a reference signal to any other terminal, the power line communication device comprising:
reception means for receiving a communication signal, a control signal, or a reference signal via a power line;
transmission means for transmitting a communication signal, a control signal, or a reference signal via a power line;
neighboring network detection means for detecting, from a signal received via the reception means, a signal from a controller of a network (hereinafter, called a neighboring network) other than a network to which the own terminal belongs, to examine a neighboring network reception state that is the reception state for a signal from a controller of a neighboring network;
comparison means for comparing the neighboring network reception state; and
controller determination means for transmitting a controller change request signal or a controller change permission signal from the transmission means and determining the controller based on the comparison result from the comparison means and/or a signal received via the reception means,
wherein in the case that the own terminal is not a controller,
the transmission means transmits the neighboring network reception state of the own terminal to the controller, and
the controller determination means transmits a controller change permission signal from the transmission means when having received a controller change request signal via the reception means, to allow the own terminal to become the controller, and
in the case that the own terminal is a controller,
the reception means receives the neighboring network reception state of a non-controller terminal,
the comparison means compares the neighboring network reception state of the own terminal, the neighboring network reception state of the non-controller terminal and a predetermined first value with one another, and
when it is found from the comparison result from the comparison means that a terminal having the best neighboring network reception state is not the own terminal, if the best neighboring network reception state is found better than the first value, the controller determination means transmits a controller change request signal to the terminal having the best neighboring network reception state requesting that the terminal having the best neighboring network reception state should become the controller, or if the best neighboring network reception state is found not better than the first value, the controller determination means transmits a controller change request signal to a non-controller terminal that has not received a neighboring network reception state via the reception means or to a terminal found to have the worst neighboring network reception state from the comparison result from the comparison means requesting that such a terminal should be the controller, and allows the own terminal to become a non-controller terminal when having received a controller change permission signal in response to the controller change request signal via the reception means.

25. The power line communication device of claim 22, wherein the neighboring network detection means examines the reception state for a signal from a controller of a neighboring network for each neighboring network, and determines a computation result of all or part of such reception states as the neighboring network reception state.

26. The power line communication device of claim 24, wherein the neighboring network detection means examines the reception state for a signal from a controller of a neighboring network for each neighboring network, and determines a computation result of all or part of such reception states as the neighboring network reception state.

27. The power line communication device of claim 22, wherein the neighboring network detection means examines the reception state for a signal from a controller of a neighboring network for each neighboring network, and determines the sum or the sum of logarithms of such reception states as the neighboring network reception state.

28. The power line communication device of claim 22, wherein the neighboring network detection means examines the reception state for a signal from a controller of a neighboring network for each neighboring network, and determines the sum or the sum of logarithms of reception states that are equal to or more than a predetermined first value as the neighboring network reception state.

29. The power line communication device of claim 21, wherein the neighboring network detection means examines the reception state for a signal from a controller of a neighboring network for each neighboring network, and determines the best reception state as the neighboring network reception state.

30. The power line communication device of claim 22, wherein the neighboring network detection means examines the reception state for a signal from a controller of a neighboring network for each neighboring network, and determines the best reception state within a fixed time as the neighboring network reception state.

31. The power line communication device of claim 24, wherein the neighboring network detection means examines the reception state for a signal from a controller of a neighboring network for each neighboring network, and determines the best reception state within a fixed time as the neighboring network reception state.

32. The power line communication device of claim 22, wherein the good neighboring network reception state represents that the reception error rate of a signal transmitted from a controller of a neighboring network is low, that the reception electric power of a signal transmitted from a controller of a neighboring network is high, that the reception rate of a signal transmitted from a controller of a neighboring network is high, or that the carrier to interference and noise ratio (CINR) of a signal received from a controller of a neighboring network is high.

33. The power line communication device of claim 24, wherein the good neighboring network reception state represents that the reception error rate of a signal transmitted from a controller of a neighboring network is low, that the reception electric power of a signal transmitted from a controller of a neighboring network is high, that the reception rate of a signal transmitted from a controller of a neighboring network is high, or that the carrier to interference and noise ratio (CINR) of a signal received from a controller of a neighboring network is high.

34. The power line communication device of claim 22, wherein the neighboring network detection means examines reception of a signal from a controller of a neighboring network for each neighboring network, and
the good neighboring network reception state represents that the number of neighboring networks detected by the neighboring network detection means is large.

35. The power line communication device of claim 22, wherein the neighboring network detection means examines reception of a signal from a controller of a neighboring network for each neighboring network, and
the good neighboring network reception state represents that the number of neighboring networks for which the reception error rate is equal to or lower than a predetermined value, or the reception electric power, the reception rate or the CINR of a received signal is equal to or higher than a predetermined value is large.

36. The power line communication device of claim 24, wherein when a terminal that has not received a neighboring network reception state or a terminal having the worst neighboring network reception state becomes the controller, the transmission means and the reception means conduct communication robust against noise for communication of all terminals in the own network.

37. The power line communication device of claim 24, wherein when a terminal that has not received a neighboring network reception state or a terminal having the worst neighboring network reception state becomes the controller, the transmission means and the reception means conduct communication with a frame divided into smaller retransmission units for communication of all terminals in the own network.

38. The power line communication device of claim 24, wherein when a terminal that has not received a neighboring network reception state or a terminal having the worst neighboring network reception state becomes the controller, the transmission means and the reception means conduct communication robust against noise for communication with a terminal that has detected a neighboring network.

39. The power line communication device of claim 24, wherein when a terminal that has not received a neighboring network reception state or a terminal having the worst neighboring network reception state becomes the controller, the transmission means and the reception means conduct communication with a frame divided into smaller re-transmission units for communication with a terminal that has detected a neighboring network.
